(19) United States
(12) Patent Application Publication
(10) Pub. No.: US 2021/0267183 A1
(43) Pub. Date: Sep. 2, 2021

(54) Elongated Fishing Sinker Device

(71) Applicant: Nathan Pramann, Becker, MN (US)

(72) Inventor: Nathan Pramann, Becker, MN (US)

(21) Appl. No.: 17/065,930

(22) Filed: Oct. 8, 2020

Related U.S. Application Data
(60) Provisional application No. 62/982,353, filed on Feb. 27, 2020.

(51) Int. Cl. A01K 95/00; A01K 91/04; A01K 85/01

(52) U.S. Cl. CPC A01K 95/00; A01K 85/01; A01K 91/04

(57) ABSTRACT

An elongated fishing sinker device is shown and described. The elongated fishing sinker device includes a swivel secured to a top section of a coupler. The swivel has a fishing line connected protrusion above the coupler. An elongated rod is secured to a bottom section of a coupler. The coupler has a hollow interior. The hollow interior houses a plurality of noise making items. These will cause a rattle as the device bounces off of the bottom of a body of water.

### CROSS REFERENCE TO RELATED APPLICATIONS

This application claims the benefit of U.S. Provisional Application No. 62/982,353 filed on Feb. 27, 2020. The above identified patent application is herein incorporated by reference in its entirety to provide continuity of disclosure.

### BACKGROUND OF THE INVENTION

The present invention relates to a fishing weight accessory. More particularly, the present invention provides a fishing weight that will hold the bait close to the bottom of a body of water while at the same time ensuring the bait does not drag on the bottom.

When fishing in large bodies of water, fish often reside along a lower section of the water. This section of the water is close to the bottom of the body of water. When fishing in these bodies of water, a common style of fishing is called trolling. When trolling a fisherman will let fishing lines out behind a boat and slowly move along. This will cause the bait on the end of the lines to rise toward the surface above the fish. In order to combat this issue, weights are added along the lines to keep them along the bottom of the body of water.

Traditionally, weights are added along the line such that line extends beyond the weight. This will ensure that the weight does not startle a fish. Unfortunately, this tactic does not allow for changes in the body of waters depth. Further, the weights may become stuck on structures at the bottom of the water. Third, the bait may drag along the bottom of the water. This means that the bait will not attract the fish at all.

Consequently, there is a need for an improvement in the art of fishing weights. The present invention substantially diverges in design elements from the known art while at the same time solves a problem many people face when using fishing weights to hold bait along the bottom of a body of water. In this regard the present invention substantially fulfills these needs.

### SUMMARY OF THE INVENTION

The present invention provides an elongated fishing sinker device, wherein the same can be utilized for providing convenience for the s when using a fishing sinker device. The elongated fishing sinker device is comprised of a swivel secured to a top section of a coupler. The swivel has a fishing line connected protruding above the coupler. An elongated rod is secured to a bottom section of a coupler.

Another object of the elongated fishing sinker device is to have a coupler with a hallow interior. The hollow interior houses a plurality of noise making items.

Another object of the elongated fishing sinker device is to have a coupler which is made from brass.

Another object of the elongated fishing sinker device is to have a swivel which is a stainless-steel swivel.

Another object of the elongated fishing sinker device is to have a barrel swivel.

Another object of the elongated fishing sinker device is to have the elongated rod made from stainless steel.

Another object of the elongated fishing sinker device is to have the elongated rod made from lead.

Another object of the elongated fishing sinker device is to have the elongated rod be hollow.

Another object of the elongated fishing sinker device is to have fewer noise making devices than the interior volume of the coupler will allow.

Another object of the elongated fishing sinker device is to have ball bearings used as the noise making devices.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the elongated fishing sinker device.

FIG. 2 shows an exploded view of an embodiment of the elongated fishing sinker device.

FIG. 3 shows cross-sectional view of an embodiment of the elongated fishing sinker device.

FIG. 4 shows a perspective view of an alternative embodiment of the elongated fishing sinker device.

FIG. 5 shows an in-use view of an embodiment of the elongated fishing sinker device.

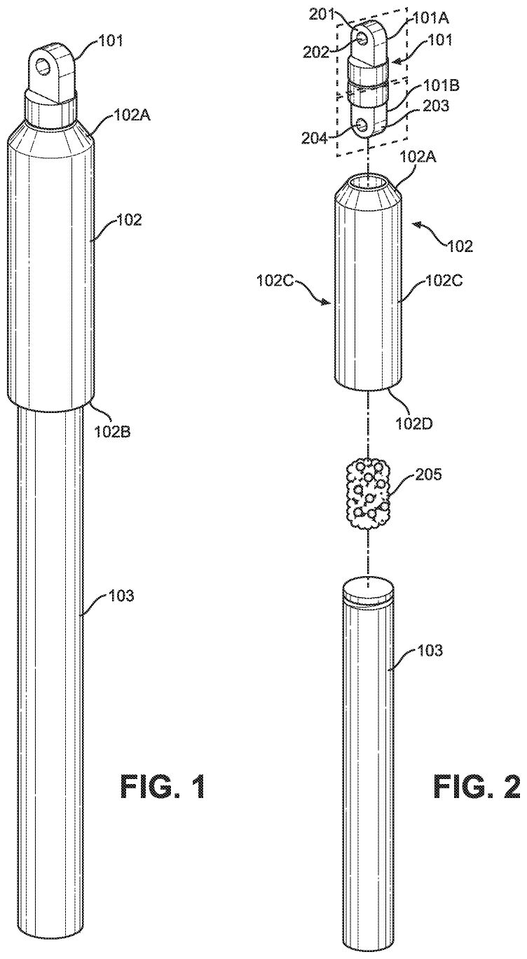

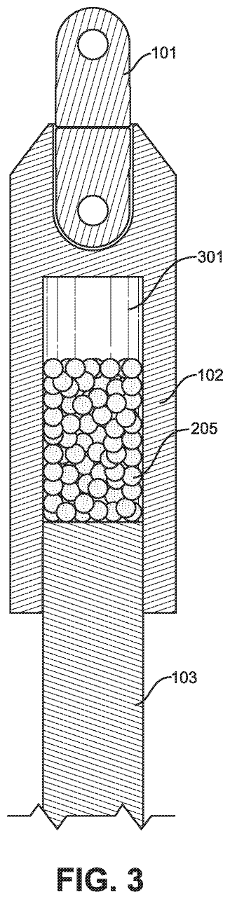

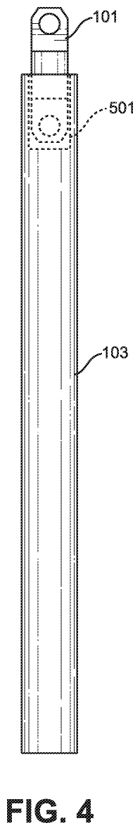

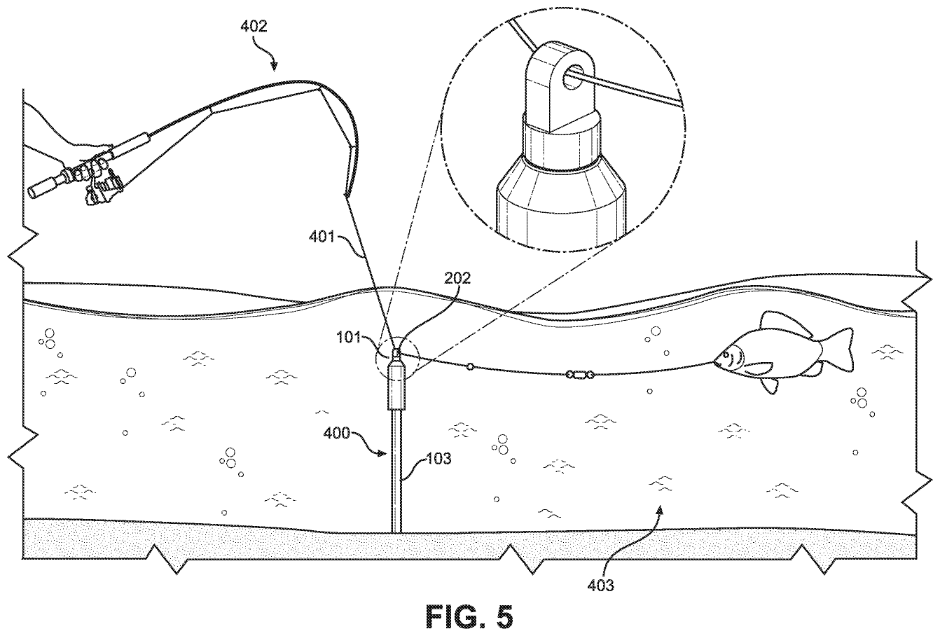

### LIST OF REFERENCE NUMERALS

With regard to the reference numerals used, the following numbering is used throughout the drawings.
101 Swivel
102 Coupler
102A First end of coupler
102B Second end of coupler
102C Parallel sides of coupler
102D Bottom of coupler
103 Elongated rod
201 Protrusion
202 Aperture
203 Second Protrusion
204 aperture
205 ball bearings
301 Interior channel
400 Elongated fishing sinker device
401 Fishing line

I claim:

1) An elongated fishing sinker device, the device comprises:
a swivel secured to a top section of a coupler;
wherein the swivel has a fishing line connected protruding above the coupler;
an elongated rod secured to a bottom section of a coupler.

2) The elongated fishing sinker device of claim 1, wherein the coupler is made from brass.

3) The elongated fishing sinker device of claim 1, wherein the swivel is a stainless-steel swivel.

4) The elongated fishing sinker device of claim 1, wherein the swivel is a barrel swivel.

5) The elongated fishing sinker device of claim 1, wherein the elongated rod is stainless steel.

6) The elongated fishing sinker device of claim 1, wherein the elongated rod is made from lead.

7) The elongated fishing sinker device of claim 1, wherein the elongated rod is hollow.

8) An elongated fishing sinker device, the device comprises:
a swivel secured to a top section of a coupler;
wherein the swivel has a fishing line connected protruding above the coupler;
an elongated rod secured to a bottom section of a coupler;
the coupler has a hollow interior, housing a plurality of noise making items.

9) The elongated fishing sinker device of claim 1, wherein the coupler is made from brass.

10) The elongated fishing sinker device of claim 1, wherein the swivel is a stainless-steel swivel.

11) The elongated fishing sinker device of claim 1, wherein the swivel is a barrel swivel.

12) The elongated fishing sinker device of claim 1, wherein the elongated rod is stainless steel.

13) The elongated fishing sinker device of claim 1, wherein the elongated rod is made from lead.

14) The elongated fishing sinker device of claim 1, wherein the elongated rod is hollow.

15) The elongated fishing sinker device of claim 1, wherein the noise making devices do not file the entire interior volume of the coupler.

16) The elongated fishing sinker device of claim 1, wherein the noise making devices are ball bearings.
